(19) United States
(12) Patent Application Publication
(10) Pub. No.: US 2026/0263851 A1
(43) Pub. Date: Sep. 10, 2026

(54) Autonomous Mobile Firefighting Robot with Thermal Imaging, Autonomous Navigation, and Targeted Fire Suppression

(71) Applicant: Ruslan Prysiazhnyi, Orlando, FL (US)

(72) Inventor: Ruslan Prysiazhnyi, Orlando, FL (US)

(21) Appl. No.: 19/071,682

(22) Filed: Mar. 5, 2025

(51) Int. Cl. A62C 27/00

(52) U.S. Cl. CPC A62C 27/00

(57) ABSTRACT

The invention relates to an autonomous mobile firefighting robot integrating fire detection sensors, autonomous navigation, and a high-pressure suppression system.

Using thermal imaging and heat mapping, the robot identifies fire hotspots, moves into position, and deploys targeted water/foam suppression.

The navigation system enables obstacle avoidance, while a remote-control interface allows manual intervention.

* Demonstration of the invention's operation—https://www.youtube.com/watch?v=iuPVkbqIoE8

### 2. FIELD OF THE INVENTION

The present invention relates to robotic firefighting systems, specifically an autonomous mobile firefighting robot capable of detecting, navigating to, and suppressing fires using real-time sensor data, autonomous decision-making, and remote control assistance. This invention applies to fire suppression in hazardous environments, such as industrial zones, urban firefighting, and emergency response situations.

### 3. BACKGROUND OF THE INVENTION

Fire suppression in high-risk areas poses a significant challenge to firefighters and emergency responders. Traditional firefighting approaches require direct human involvement, exposing personnel to intense heat, toxic gases, and unstable structures.

Current robotic firefighting solutions present limitations such as:
Lack of autonomous navigation, requiring human control for movement and positioning.
Limited fire detection capability, reducing responsiveness to dynamic fire conditions.
Inefficient suppression targeting, leading to unnecessary resource expenditure.

The present invention addresses these challenges by introducing an autonomous mobile firefighting robot, integrating advanced fire detection sensors, intelligent navigation, and a targeted fire suppression system.

### 4. SUMMARY OF THE INVENTION

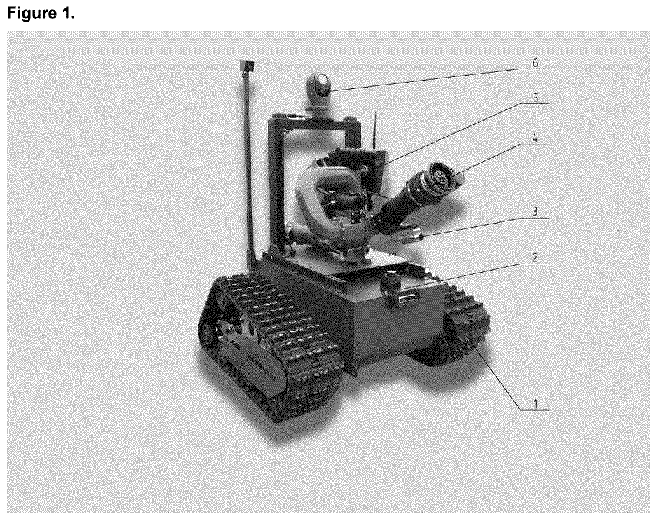

The invention provides a mobile firefighting robot, featuring:
A tracked, all-terrain chassis (FIG. 1, pos. 1) for movement in hazardous and debris-filled environments.
Autonomous navigation sensors (FIG. 1, pos. 2, 6), including a depth camera, LiDAR, and GNSS, enabling self-positioning and path planning.
Autonomous fire detection sensors and cameras (FIG. 1, pos. 3), identifying fire hotspots, smoke, and heat sources in real-time.
A high-pressure firefighting cannon (FIG. 1, pos. 4), capable of deploying water or foam at adjustable pressure and spray patterns.
A control box for a high-pressure firefighting cannon unit (FIG. 1, pos. 5), responsible for control of the firefighting cannon.

This system ensures efficient, rapid, and adaptable firefighting, reducing risks to human personnel while optimizing resource utilization.

### 5. BRIEF DESCRIPTION OF THE DRAWINGS

FIG. 1: Isometric view of the mobile firefighting robot, showing:
Tracked chassis (1) for movement and stability.
Reinforced body housing electronic control systems.
Autonomous navigation sensors (2, 6), including a depth camera, LiDAR, and GNSS, enabling precise self-positioning.
Autonomous fire detection sensors and cameras (3), identifying fire sources in real-time.
High-pressure firefighting cannon (4), capable of controlled water/foam suppression.
Control box (5), managing firefighting operations and remote command integration.

### 6. DETAILED DESCRIPTION OF THE INVENTION

### 6.1 Structure and Components

### 1. Tracked Chassis (FIG. 1, Pos. 1)

The robotic platform features a durable, all-terrain tracked chassis, ensuring mobility in urban, industrial, and hazardous environments.
High-torque electric motors enable movement over obstacles, debris, and uneven surfaces.
Constructed from impact-resistant materials, allowing operation in high-temperature zones.

### 2. Reinforced Body

Protects electronic control units, processing hardware, and power systems.
Features thermal shielding, ensuring functionality in prolonged exposure to high heat.
Houses an internal battery, providing extended operational time in emergency conditions.

### 3. Autonomous Navigation Sensors (FIG. 1, Pos. 2 and 6)

The robot incorporates a multi-sensor navigation system, including:
   Depth camera, enabling spatial awareness and obstacle detection.
   LiDAR, generating a 3D environmental map for accurate path planning.
   GNSS (Global Navigation Satellite System), providing precise geolocation tracking.
These sensors enable the robot to autonomously navigate to fire hotspots while avoiding obstacles.

### 4. Autonomous Fire Detection Sensors and Cameras (FIG. 1, Pos. 3)

Equipped with thermal imaging cameras and optical sensors, enabling:
   Detection of fire hotspots, identifying the highest-temperature zones for suppression.
   Heat mapping, continuously monitoring fire behavior, and adjusting suppression tactics.
   Smoke and flame recognition, distinguishing between active flames, embers, and residual heat.

### 5. High-Pressure Firefighting Cannon (FIG. 1, Pos. 4)

The fire suppression system features a movable, high-pressure cannon, capable of deploying:
   Water, for standard firefighting operations.
   Foam, for specialized applications such as chemical or fuel-based fires.
The cannon features:
   Adjustable spray patterns, optimizing suppression effectiveness.
   Automated targeting, directed by thermal imaging and fire detection sensors.

### 6. Control Box (FIG. 1, Pos. 5)

Enables remote operator monitoring and override, allowing human intervention in mission-critical scenarios.

### 6.2 Principle of Operation

### 1. Fire Detection and Autonomous Navigation

The autonomous fire detection sensors (FIG. 1, pos. 3) identify heat sources and fire locations.
The navigation system (FIG. 1, pos. 6) determines the optimal route to the fire.
The robot moves into position, ensuring maximum suppression efficiency.

### 2. Targeted Fire Suppression

The firefighting cannon (FIG. 1, pos. 4) engages the fire, adjusting spray pattern and pressure based on fire intensity.
The robot continuously monitors fire suppression effectiveness, modifying its approach as needed.

### 3. Real-Time Adjustment and Remote Control

The robot transmits fire mapping data to an operator, enabling manual intervention if necessary.
If the fire spreads, the robot autonomously adjusts targeting and repositions itself.
   * Demonstration of the invention's operation—https://www.youtube.com/watch?v=iuPVkbqIoE8

1. A mobile firefighting robot, comprising:
a tracked, all-terrain chassis (FIG. 1, pos. 1) for movement across hazardous environments;
an autonomous fire detection system (FIG. 1, pos. 3), including thermal imaging cameras and heat-mapping software;
a navigation module (FIG. 1, pos. 2 and 6), integrating depth cameras, LiDAR, and GNSS for self-positioning and obstacle avoidance;
a high-pressure water/foam suppression system (FIG. 1, pos. 4), with automated targeting based on real-time fire data;
a processing and control unit (FIG. 1, pos. 5), responsible for control of the firefighting cannon and remote operator override.

1. The firefighting robot of claim 1, wherein the fire detection system continuously monitors and adjusts suppression targets.

2. The firefighting robot of claim 1, wherein the navigation module enables the robot to autonomously position itself based on environmental conditions.

3. The firefighting robot of claim 1, wherein the fire suppression system includes adjustable pressure and spray patterns for different fire types.
